(19) United States
(12) Patent Application Publication
(10) Pub. No.: US 2005/0255429 A1
(43) Pub. Date: Nov. 17, 2005

(54) Novel teaching methodology and syllabus

(76) Inventor: Linda R. Robbie, Baytown, TX (US)

Correspondence Address: GORDON G. WAGGETT, P.C., 3200 SOUTHWEST FREEWAY, SUITE 2355, HOUSTON, TX, 77027, US

(21) Appl. No.: 11/128,869

(22) Filed: May 13, 2005

Related U.S. Application Data
(60) Provisional application No. 60/571,153, filed on May 14, 2004.

(51) Int. Cl. G09B 19/00; G09B 7/00

(52) U.S. Cl. 434/154

(57) ABSTRACT

The present invention relates to the use of a multisensory, multimedia approach to learning that can be employed with students in any disciplines. A preferred embodiment describes a multi-sensory method of teaching comprising: selecting at least one specific historical time period; obtaining, reviewing and compiling subject matter information relevant to the time period; performing text analysis of the compiled subject matter information; Assembling the text analysis results; defining a subject matter genre based on the text analysis; organizing and dividing the subject matter genre into discreet subparts; and presenting the information. The genre information can be assembled into one or more discreet packages such as a reference, syllabus, handout, teacher's guide, teaching kit, class textbook and/or syllabus. This method can used to prepare students for standardized test taking. A kit for use in providing the multi-sensory method of teaching is described and can include a syllabus and/or audio visual materials.

### CROSS-REFERENCE TO RELATED APPLICATIONS

This application claims the benefit of the filing date of copending U.S. Provisional Patent Application Ser. No. 60/571,153 filed May 14, 2004, Confirmation No. 1496.

### STATEMENT REGARDING FEDERALLY SPONSORED RESEARCH OR DEVELOPMENT

Not Applicable.

### BACKGROUND OF THE INVENTION

The present invention is generally directed to a novel methodology for teaching and a syllabus and/or kit employing such methodologies. More particularly, the present invention relates to the use of a multisensory, multimedia approach to learning that can be employed with students in many disciplines, including reading, writing, history, fine arts, language, and other subjects of interest. The teaching methodologies and syllabus materials of the present invention can be used to advantage with students of various ages, such as young children in pre-school, students in elementary, middle and high schools, as well as adults. Further, the methodologies and materials of the present invention can also be employed to teach other instructors how to enhance their own teaching skills (a teach the teacher application).

Over decades of observation within the educational profession, one of the greatest obstacles to a student's ability to learn is a lack of motivation. This motivational challenge is particularly challenging with students of younger ages, such as those in upper elementary, junior high school and high school. Educators are constantly searching for ways to overcome this motivational obstacle, but to-date, have not found a satisfactory solution. This search has led to the development of the present invention, a curriculum and teaching method referred to as “LEARNING THRU THE DECADES” which provides the motivational basis that has been lacking with prior teaching techniques and educational products.

### BRIEF SUMMARY OF THE INVENTION

In a preferred embodiment of the present invention there is described a multi-sensory method of teaching comprising the following steps:
a. Selecting at least one specific historical time period;
b. Obtaining, reviewing and compiling subject matter information relevant to the selected time period;
c. Performing a text analysis of the compiled subject matter information;
d. Assembling the results of the text analysis;
e. Defining a subject matter genre based on the text analysis;
f. Organizing and dividing the subject matter genre into discreet subparts;
g. Presenting the information relating to the discreet subparts over a desired period of time to one or more students.

The selected time period can be any time period, such one selected from the group consisting of a decade, era, age, and year. In a preferred embodiment, a decade is selected as the time period.

The text analysis step can preferentially include the steps of searching for patterns of overlap between words and phrases in the subject matter information and searching for other relationships amongst and between the compiled subject matter information from the selected time period. These relationships can include word associations, common themes, common places, common people, common things, common words, common word meanings (synonyms), opposite word meanings (antonyms), plays on words, and any other data points of interest that have a common link amongst and between the compiled subject matter from the selected time period. In a preferred embodiment, the compiled subject matter includes information obtained about events, people, things, places, arts, discoveries, and other items of interest from the selected time period. Any number of persons can conduct the text analysis, however, a preferred person would be the teacher that presents the material. The text analysis can be carried out with the aid of computer software.

In a preferred embodiment, the presentation of each genre utilizes one or more multimedia presentation formats. The multimedia presentation formats can include those selected from the group consisting of audio, visual, written, music, song lyrics, video clips, internet articles, webcasts, streaming video/audio, live reading, singing, performance, book excerpts, magazine excerpts, dance routines, physical exercise routines, music CDs, MP3s, posters, drawings, and paintings.

Another preferred embodiment includes the additional step of assembling the organized information for each genre into one or more discreet packages. These discreet packages can comprise a reference, syllabus, handout, teacher's guide, teaching kit, class textbook and/or syllabus.

Another preferred embodiment of the present invention comprises the additional step of incorporating into one or more of the genre information that is relevant to the preparation of the student for taking a standardized test.

In yet another preferred embodiment of the present invention, the discreet packages can be assembled into a kit for use in providing the multi-sensory method of teaching. In a preferred embodiment, this kit comprises a syllabus outlining one or more subject matter genre to be taught in a desired course of study. The subject matter genre preferably is selected by textual analysis of compiled subject matter information relevant to at least one selected time period. The kit also preferably comprises audio and visual materials supporting the subject matter genres.

A product of this invention can also be a course curriculum that can be used by a teacher to prepare for and teach a class.

### DETAILED DESCRIPTION OF THE INVENTION

The LEARNING THRU THE DECADES methodology and program of the present invention is a novel approach for teaching, e.g., reading and writing to students. This program utilizes a multi-sensory approach to learning, enabling students to improve both vocabulary and comprehension skills, increasing their awareness of the past and helping them prepare and master various examinations that they may be required to take, such as state mandated assessment tests (e.g., the Texas Assessment of Skills test (TAKS)).

The LEARNING THRU THE DECADES program offers a curriculum that preferably encompasses reading, writing, history and fine arts and can be adapted to fit any curricula. The program motivates students to not only be better readers, but also to be more frequent readers. It creates a desire for learning through the use of multimedia materials that are appealing to students, and as a result, their education will improve. With improved education, comes the ability for the students to better prepare for various examinations, and to improve their scores on such examinations. In addition, students will learn more about their environment, both past and present. Finally, the culturally diverse approach of the LEARNING THRU THE DECADES program transcends socio-economic boundaries.

The LEARNING THRU THE DECADES curriculum uses many tools to motivate students. These include internet articles, biographies, excerpts from literary works, newspapers and magazine articles, TV tunes, animated cartoons, posters, comic books, music (including lyrics), television shows and movies. Although teachers already use many of these tools, the present invention presents a novel way in which the weekly (or other length) “units” (or lesson plans) are structured and organized (by decades and genres), and in which the reading selections themselves are employed.

In a preferred embodiment of the present invention there is described a novel method of teaching comprising the following steps:
Selecting a specific historical time period, such as, a specific historical Decade (ten year period), an Era, Age, Year or other desired length of time (hereinafter “the Selected Time Period”). In a preferred embodiment of the present invention, the Selected Time Period is a Decade.
Reviewing and compiling information about events, people, things, places, arts, discoveries, and other items of interest (hereinafter collectively “the Subject Matter”) from the Selected Time Period;
Performing a text analysis of the compiled Subject Matter to search for patterns of overlap between words and phrases in the Subject Matter and other relationships amongst and between the compiled Subject Matter from the given Selected Time Period. Such other relationships can include word associations, common themes, common places, common people, common things, common words, common word meanings (synonyms), opposite word meanings (antonyms), plays on words, and any other data points of interest that have some tie, even remotely, amongst and between the compiled Subject Matter from the Selected Time Period. In a preferred embodiment of the present invention, a person(s), such as a teacher, conducts the text analysis manually via personal study and review. In an alternative preferred embodiment, computer textual analysis can be performed to map the textual relationships found within the compiled Subject Matter. Such software is known in the art. One example of the type of computer textual analysis software known in the art is the “AUREKA™” patent mapping software offered by Micropatent, Inc. used to map and display textual analysis found amongst and between various patents of interest.
Assembling the results of the text analysis and coining a creative label for such results that will be referred to as the “Genre”. The definition of the Genre is preferably a short phrase, slogan or the like that tends to identify, generically, the identification of the Subject Matter so assembled, but does not necessarily have to reveal the identification of the Subject Matter so assembled.
If more than one Selected Time Period is desired, an alternate preferred embodiment of the present invention employs the additional step of determining how many Selected Time Periods are desired to employ within the overall teaching methodology. If more than one Selected Time Period is desired, then steps 1-4 are repeated for each Selected Time Period.
Organizing and dividing the Genre into subparts to be presented to students over a desired length of time. For example, in a preferred embodiment, each Genre is divided up into separate topics that can be presented, using multimedia, over the course of one week. A number of Genres can be linked together as part of a curriculum designed to last 3, 6, or 9 weeks (or other desired length of time). The presentation of each Genre is preferably organized to use a variety of multimedia presentation formats, such as, audio, visual, written, music, song lyrics, video clips, internet articles, webcasts, streaming video/audio, live reading, singing, or other performance, book/magazine excerpts, dance routines, physical exercise routines, music CDs, MP3s, posters, drawings, paintings.
Another preferred embodiment of the present invention includes the step of assembling the collected and organized materials for each Genre into one or more discreet packages for use as a reference, handout, teacher's guide, class textbook, syllabus and/or the like.

The order in which the above steps (or alternate steps) are performed may be altered keeping in mind that it is preferred that the textual analysis step will follow the step of defining the Subject Matter.

As an example of a preferred embodiment of the present invention, the 1960's Decade was chosen as the Selected Time Period. Subject Matter from the 1960's Decade was compiled. It was decided to divide this Decade into nine, one-week units, each unit consisting of a different Genre pertaining to the 1960's Decade. The decision to create nine Genres was based on the particular course schedule of the instructor, and can vary as desired. During the process of textual analysis, which was performed manually by the instructor, the following Genres were defined:

Week 1: “A, B, C, D”. The course materials for this unit further consisted of multimedia materials regarding “A” the Andy Griffith Show (including a reference to the biography of Ron Howard who played the role of Opie as a child and a showing of one 30-minute episode); “B” Berry Gordy (of MOTOWN Records music fame); “B” James Brown (including his biography, his music, and lyrics to his music); “C” Chubby Checker (including his biography, music, lyrics, and information regarding the dance “the Twist”; and “D” for Dances of the 60's (including reading selections, music, and dance). Additional cross-relational information for this unit included other works of Ron Howard, such as his famous role as an adult in the TV series “Happy Days”. Additional course materials were designed using this subject matter and formatting to aid in the preparation for standardized tests—written and oral questions, writing activities. Sources for such materials can be obtained from, e.g., libraries, bookstores, music stores, CDs, and internet websites (such as, for example, tvtunesonline.com; sitcomsonline.com; Hollywood.com; tvland.com; cosmopolis.ch; theiceberg.com; slyrics.com; worldbook.com; wtv-zone.com; history-of-rock.com; chubbychecker.com; classicbands.com; streetswing.com; ahwatukee.com; lyricsxp.com; lyricsdepot.com; oldies.about.com; geocities.com/thehipstergogo/history.html). Similar types of formats and sources as used in Week 1 can be employed in the following Genres (Weeks).

Week 2: “Country Week”. The course materials for this unit further consisted of multimedia materials regarding country singers Johnny Cash, Dolly Parton, Loretta Lynn, Willie Nelson, and country-westem themed television shows “Bonanza”, “Petticoat Junction”, and “Green Acres”. Sources for such materials can be obtained from, e.g., libraries, bookstores, music stores, CDs, and internet websites (such as, for example, countrypolitan.com; entertainment.msn.com/movies; countrygolduse.com; sc.essortment.com; coquet-shack.com/lyrics; vhl.com/artists; users.csbsju.edu/˜sjfisch/lyrics.htm; johnwaynebirthplace.org; tvtome.com; members.aol.com/fortscott, top50lyrics.com; willienelson.com; smickandsmodoo.com/aaa/lyrics; allyourtv.com; museum.tv, rollingstone.com; allsands.com/entertainment/people; and maggiore.net/greenacres.

Week 3: “Animals, Insects & Pests”. The course materials for this unit further consisted of multimedia materials regarding the music groups “The Monkeys” and “The Beatles”, as well as TV shows/movies “Flipper” (about a dolphin), “Denise the Menace” (classic youngster considered to be a “pest”, “Mr. Ed” (talking horse), and “Batman”.

Week 4: “Super Women”. The course materials for this unit further consisted of multimedia materials regarding Former First Lady Jacquelyn Onassis Kennedy, the BARBIE® doll, Actress Audrey Hepburn; the movie/book “Breakfast at Tiffanys”; Wilma Rudolph, Celia Cruz, Tina Turner.

Week 5: “Space, Out of this World and On Top of the World”. The course materials for this unit further consisted of multimedia materials regarding the Apollo space program with Neal Armstrong as the first man on the moon, “Star Trek”, Isaac Asamov (science fiction), The Byrds (Spaceman song); “I Dream of Jeannie”, “The Jetsons”, the 4 Tops, and a short story entitled “To Serve Man” by Daman Knight.

Week 6: “Marvelous Men”. The course materials for this unit further consisted of multimedia materials regarding John F. Kennedy, Robert Kennedy, Martin Luther King, Jr., Cesar Chavez, Cary Grant, The Temptations, Marvin Gay, Johnny Carson and Tito Puente.

Week 7: “Sun, Sand & Fun”. The course materials for this unit further consisted of multimedia materials regarding Sandra Dee (actress who played role of “Gidget”), Jan & Dean, The Beachboys, and the TV show “Gilligan's Island”.

Week 8: “Super & Supreme”. The course materials for this unit further consisted of multimedia materials regarding Diana Ross & The Supremes, the TV show “Bewitched” (about super powers), Woodstock, The Jackson 5, Muhammad Ali, and Wilt Chamberlain.

Week 9: “All in the Family”. The course materials for this unit further consisted of multimedia materials regarding famous families, including from television, “The Beverly Hillbillies”, “The Dick Van Dyke Show”, “The Jackson 5”, and “The Munsters”.

The above 9-Week syllabus is a preferred example syllabus that can be created pursuant to the present invention, it being understood that the selection of the Selected Time Period, the Subject Matter from such Time Period, and the Genres from such Subject Matter can be varied according to the interests or needs of the instructor, course, and/or students. Further, the modes of multimedia presentation of each Genre can be varied and tailored according to the specific needs or desires of the instructor, course and/or students.

In a preferred embodiment of the present invention, the reading excerpts vary in length to help even the most reluctant reader by not “bogginlg” them down with extended reading assignments. In addition, the reading excerpts are preferably combined with motivational audio-visual materials that help bring the articles to life. Students are given assignments where they compare and contrast the characters, discuss plot development and expound on the historical importance of what they have read and heard. Preferably, these units are done on a weekly basis throughout the school year, although other time frames can be employed. In short, the students are motivated to improve their reading and writing skills because they enjoy the experience.

The present invention provides many advantages over existing classroom teaching methodologies. For example, the novel teaching program of the present invention appeals to students. It advantageously employs entertainment and the arts to motivate them.

Further, the materials provided in this novel curriculum are helpful in developing schema needed as the basis for the understanding of new concepts. Many students, especially those from depressed socio-economic backgrounds, lack the experiences and knowledge necessary to comprehend new concepts and ideas. This becomes a deterrent to learning. The materials provided in the preferred embodiments of the present invention introduce students to an abundance of new ideas to be used in their reading and writing activities. Students can utilize these ideas now or store them in their “toolbox” until later.

Additionally, this program links the past and the present. Students get an understanding of how society has changed by reading about the people, events, arts and entertainment that influenced those changes.

This program of the present invention teaches students how diverse cultures have interacted to create the environment of today.

This novel program offers teachers who teach reading, writing, and history an easy approach to link the curriculum without searching for extra reading selections.

This program also employs materials that meet school district mandated guidelines for the use of videos.

Moreover, the present invention provides an innovative, interesting and fun way to practice for the state mandated reading and writing tests, and other examinations.

This program stimulates further learning. After studying a particular decade, teachers can assign, or students can choose additional people, events, literary passages, musical lyrics, television shows or movies from that decade to research.

This program is versatile and can be structured to fit the teacher's needs. In yet another preferred embodiment, it can be used daily, weekly, or periodically throughout the school year.

The materials provided with the teaching methodology of the present invention can be used to study a particular genre. For example, during a popular local current event, such as an annual rodeo, the teacher can create a country and western genre unit, utilizing applicable reading selections, music and videos from several decades.

In yet another preferred embodiment of the present invention, the materials found in this program can be used in cross curriculum teaching lessons.

The individual sets of materials used in this novel curriculum are available from a number of resources. The present invention packages these materials together by decade or genre to inspire children and other students to read, write and think by making learning fun. This is a program where students can share the accomplishment of their race and pride in their heritage, where all children, regardless of their socio-economic background, have an opportunity to share experiences through entertainment and the arts, and where they can realize and appreciate that through diversity we are a more unique and exciting country.

In yet another preferred embodiment of the present invention, after choosing the decade to be studied, establishing the weekly genres, and gathering the materials to be utilized in the curriculum (articles, music, lyrics, videos, etc.), the teacher is ready to present the daily/weekly lessons. A short class discussion concerning the person or event to be studied helps students to have some prior knowledge and also promotes an interest in the selected reading assignment. During the reading of the passage, the teacher asks questions (usually after every 2-3 paragraphs) to test for basic understanding. These questions can be as simple as recalling facts, summarizing or understanding vocabulary and/or the main idea or as complex as cause and effect, making inferences, judgments or evaluating the literary work. Class discussions can stimulate critical thinking.

In another preferred embodiment of the present invention, once the reading selection has been completed, music and lyrics can be used to promote listening skills, music appreciation and help improve reading skills such as context clues, sequencing and author's purpose. Music is also important in its effect on society, and students' understanding of the impact of a particular song or type of music can help in the overall understanding of the lesson being studied.

During the weekly video, students can practice note-taking skills and/or prepare for a writing activity that can include character analysis, plot development, comparing and contrasting, summarizing, evaluating the video and/or writing a personal response composition.

The activities can be as varied as the imagination and creativity of the classroom teacher. There are a variety of ways to implement this curriculum to help students improve reading and writing skills, as well as to help students become critical thinkers.

Another preferred embodiment of the invention comprises a teaching aid kit that packages together the syllabus and associated materials as a teaching aid kit for distribution to teachers, consultants, instructors, and others who desire to utilize the curriculum of the present invention.

While the apparatus and methods of this invention have been described in terms of preferred embodiments, it will be apparent to those of skill in the art that variations may be applied to the process described herein without departing from the concept and scope of the invention. All such similar substitutes and modifications apparent to those skilled in the art are deemed to be within the scope and concept of the invention.

1. A multi-sensory method of teaching comprising the following steps:
a. Selecting at least one specific historical time period;
b. Obtaining, reviewing and compiling subject matter information relevant to the selected time period;
c. Performing a text analysis of the compiled subject matter information;
d. Assembling the results of the text analysis;
e. Defining a subject matter genre based on the text analysis;
f. Organizing and dividing the subject matter genre into discreet subparts; and
g. Presenting the information relating to the discreet subparts over a desired period of time to one or more students.

2. The method of claim 1 wherein the selected time period is selected from the group consisting of a decade, era, age, and year.

3. The method of claim 1 wherein the selected time period is a decade.

4. The method of claim 1 wherein the text analysis includes the steps of searching for patterns of overlap between words and phrases in the subject matter information and searching for other relationships amongst and between the compiled subject matter information from the selected time period.

5. The method of claim 4 wherein the relationships include word associations, common themes, common places, common people, common things, common words, common word meanings (synonyms), opposite word meanings (antonyms), plays on words, and any other data points of interest that have a common link amongst and between the compiled subject matter from the selected time period.

6. The method of claim 1 wherein the compiled subject matter includes information obtained about events, people, things, places, arts, discoveries, and other items of interest from the selected time period.

7. The method of claim 1 wherein one or more persons conduct the text analysis via personal study and review.

8. The method of claim 7 wherein the one or more persons is a teacher or teachers.

9. The method of claim 1 wherein the steps are carried out by a teacher.

10. The method of claim 1 wherein one or more persons conduct the text analysis via computer software.

11. The method of claim 1 wherein a label is coined for the genre.

12. The method of claim 1 comprising the additional step of determining how many time periods to select.

13. The method of claim 1 wherein the presentation of each genre utilizes one or more multimedia presentation formats.

14. The method of claim 14 wherein the multimedia presentation formats are selected from the group consisting of audio, visual, written, music, song lyrics, video clips, internet articles, webcasts, streaming video/audio, live reading, singing, performance, book excerpts, magazine excerpts, dance routines, physical exercise routines, music CDs, MP3s, posters, drawings, and paintings.

15. The method of claim 1 comprising the additional step of assembling the organized information for each genre into one or more discreet packages.

16. The method of claim 15 wherein the one or more discreet packages comprise a reference, syllabus, handout, teacher's guide, teaching kit, class textbook or syllabus.

17. The method of claim 1 comprising the additional step of incorporating into one or more of the genre information that is relevant to the preparation of the student for taking a standardized test.

18. A kit for use in providing a multi-sensory method of teaching comprising:
a. A syllabus outlining one or more subject matter genre to be taught in a desired course of study;
the one or more subject matter genre being selected by textual analysis of compiled subject matter information relevant to at least one selected time period, and
b. Audio and visual materials supporting the one or more subject matter genre.
